(19) United States
(12) Patent Application Publication
(10) Pub. No.: US 2014/0100915 A1
(43) Pub. Date: Apr. 10, 2014

(54) Systems and Methods for Estimating Sales and Marketing Parameters for a Product

(71) Applicant: MOTOROLA MOBILITY LLC, Libertyville, IL (US)

(72) Inventor: Amanpreet Singh, Buffalo Grove, IL (US)

(73) Assignee: Motorola Mobility LLC, Libertyville, IL (US)

(21) Appl. No.: 13/647,424

(22) Filed: Oct. 9, 2012

(51) Int. Cl. G06Q 30/02

(52) U.S. Cl. CPC G06Q 30/0202
USPC 705/7.31

(57) ABSTRACT

Systems and methods are provided for determining sales estimates and budget parameters associated with a release of a product. According to certain aspects, an electronic device identifies (505) a total available market (TAM) for a product over specified time periods. The electronic device selects (515) various component-related features of the product and compares (520) the features to those of competing products and, based on the comparison, calculates (540) an overall product factor for the product. In aspects, the electronic device compares the overall product factor to the TAM to calculate (545) a share of available market (SAM) for the product over the time periods. In embodiments, the processing module can determine budget parameters associated with a release of the product based on a target SAM for the product over the time periods.

### FIELD

This application generally relates to estimating or forecasting sales and marketing data for a product. In particular, the application relates to platforms and techniques for determining a market share forecast and/or spending budgets for a product.

### BACKGROUND

Analyzing market share and market size can help enterprises better estimate sales figures for particular products. Various conventional techniques exist for generating market share or market size models. Particularly, the conventional market size models are based on historical sales data, seasonality factors, technology penetration estimates, and other factors.

There may be other factors, however, that are not considered. As a result, the market share and market size models can underestimate or overestimate various parameters as a result of the unaccounted-for factors. Accordingly, there is an opportunity for implementing market share and market size models and budget estimate techniques that account for additional factors.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 illustrates an example chart detailing component-related factors in accordance with some embodiments.

FIGS. 2A and 2B illustrate an example chart detailing market share calculations in accordance with some embodiments.

FIG. 3 is a block diagram of a computer system in accordance with some embodiments.

FIG. 4A and FIG. 4B illustrate example input/output diagrams in accordance with some embodiments.

FIG. 5 depicts a flow diagram of market share processing in accordance with some embodiments.

FIG. 6 depicts a flow diagram of market share processing in accordance with some other embodiments.

### DETAILED DESCRIPTION

Systems and methods determine or estimate market shares for product forecasts and budget parameters associated therewith. More particularly, the systems and methods identify a total available market (TAM) for a product over specified time periods and modify the TAM based on one or more marketplace factors. According to embodiments, the product has component-related features that consumers (i.e., end users) and customers (e.g., retailers or distributors) consider when deciding whether to purchase the product. For electronic computing devices, as an example, component-related features may include display color gamut, processor speed, and amount of RAM. Examples of features that are not component-related include: amount or popularity of third party software applications, sample music or games preloaded onto the product, accessories (e.g., printer, replacement keyboard, additional monitor, etc.), salesperson recommendations, financing availability, warranty, and technical support. Although these factors influence purchasing decisions, they are not directly related to an aspect of a hardware component of the product.

The systems and methods compare the component-related features of a product to those of competing products and determine an overall product factor for the product based on the comparison. Further, the systems and methods calculate a share of available market (SAM) for the product based on the overall product factor as applied to the modified TAM.

According to embodiments, the systems and methods can further estimate pricing and budget parameters (e.g., price points, marketing spending budgets) based on a target SAM for a product as well as the determined overall product factor. Further, the systems and methods can update the SAM and pricing and budget parameters after a portion of the time period has elapsed, for example after the product has been released. In embodiments, the SAM and other parameters can be updated based on consumer reviews of the product and/or competing products, remaining supplies of relevant components, estimated availabilities of relevant components, and/or other factors. It should be appreciated that the systems and methods as described herein can be applied in demand forecasting models across various industries to drive accurate supply requests, capacity planning, and sales estimates.

The described systems and methods offer improved market size and market share models and techniques. Particularly, the models provide for greater accuracy by offering direct, hardware-based comparisons to competing products. As a result, the models offer a streamlined approach to improve the timeliness and robustness of a demand-driven forecasting cadence as well as enable an enhanced informational database for further analyses of new products. Additionally, the models enable enterprises to forecast demand based on different scenarios and market assumptions which can drive the range of demand of components to suppliers. Moreover, the models offer baseline analyses to more accurately track customer and consumer purchases.

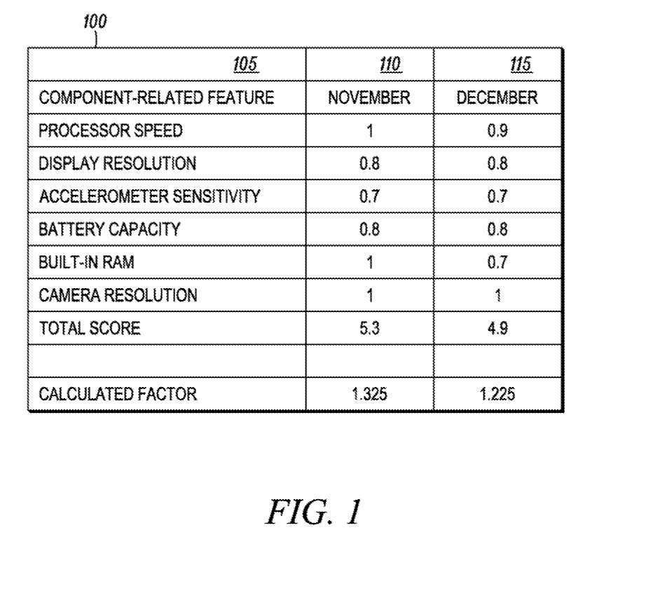

FIG. 1 depicts an example chart 100 that details example weights for component-related features of a product at various time periods. For purposes of explaining the chart 100, it can be assumed that the product is a mobile smartphone. However, it should be appreciated that other products, associated component-related features, time periods, and combinations thereof are envisioned. Further, it should be appreciated that the weights for the component-related features can be assigned, determined, or adjusted according to any technique or convention.

Referring to FIG. 1, the chart 100 lists six (6) component-related features 105 for the smartphone, namely, processor speed, display resolution, accelerometer sensitivity, battery capacity, built-in RAM, and camera resolution. Each of the component-related features 105 can have associated specifications or attributes. For example, the processor can have a speed (1.5 GHz), the display can have a resolution (702×1280 px), the battery can have a capacity (e.g., 3300 mAh), the camera can have a resolution (e.g., 10 megapixels), etc. According to embodiments, the component-related features as discussed herein can be understood to be any features of a product that are associated with various physical components.

The chart 100 also lists weights for each of the component-related features 105 for two different time periods. Particularly, as shown, the chart 100 lists a weight column 110 for November and a weight column 115 for December. According to embodiments, a processing or electronic device (not shown in FIG. 1) can calculate, determine, or otherwise assign the weights for each of the weight columns 110, 115 based on various factors. In some cases, a user can interface with the electronic device to input various information or data that the electronic device can use to calculate, determine, or otherwise assign the weights. According to embodiments, the weights are based on how the corresponding component-related feature compares to the specifications of that component-related feature in one or more competing products at a particular time period. Note that a competing product may be provided by the same manufacturer as the subject product; also a competing product may be provided by a competing manufacturer. Also, a competing product should be in the same product category (and sub-category, if applicable) as the subject product.

For example, in the November time period, the smartphone may have a processor with a clock frequency of 1.5 GHz and three competing smartphones may have processors with respective clock frequencies of 1.1, 1.2, and 1.0 GHz (i.e., the processor of the smartphone is considered superior to those of the competing smartphones). Accordingly, referring to FIG. 1, the electronic device can determine that the processor has a weight of “1” for the November time period as shown in column 110. In this case, the weight of “1” indicates that for the November time period, the processor of the smartphone is considered uniquely superior to processors of competing smartphones. It should be appreciated that the systems and methods as discussed herein can compare the component-related features of products to the same features or to similar or equivalent features of competing products.

For further example, in the November time period, the smartphone may have a battery capacity of 2800 mAh and three competing smartphones may have batteries with respective capacities of 2200 mAh, 2600 mAh, and 3300 mAh (i.e., the battery capacity of the smartphone is considered superior to all but one of the batteries of the competing smartphones). Accordingly, referring to FIG. 1, the electronic device can determine that the battery capacity has a weight of “0.8” for the November time period as shown in column 110. In this case, the weight of “0.8” indicates that for the November time period, the battery of the smartphone is considered better than all but one of the batteries of the competing smartphones.

In further cases, the weights are also based on the associated time period or otherwise the passage of time. Referring to the previous processor example, if a competing smartphone with a release date in December will also have a processor with a clock frequency of 1.5 GHz, then the electronic device can determine that the processor has a weight of “0.9” for the December time period as shown in column 115 (i.e., when the competing smartphone is released, the subject smartphone will no longer have a uniquely superior processor speed). In this case, the weight of “0.9” indicates that for the December time period as shown in column 115, the processor speed of the smartphone is considered better than most, but not all, of the processors of the competing smartphones yet no processor speed is better than the subject smartphone's processor speed.

Further, in embodiments, various of the component-related features of the smartphone can experience a natural decay that can affect the weights. For example, in the November time period, the 2 GB RAM capacity of the smartphone may be the single largest amount available from any smartphone, but as of the December time period, several smartphones are expected to have 2 GB RAM. Accordingly, as shown in FIG. 1, the electronic device can determine that the weight of the built-in RAM for the November time period as shown in column 110 is “1” and the weight of the built-in RAM for the December time period as shown in column 115 is “0.7”.

In embodiments, the electronic device can calculate a total score for each of the time periods as shown in columns 110, 115 based on the determined weights for the component-related features. As shown in FIG. 1, the total score is a sum of the determined weights, which equals 5.3 for the November time period as shown in column 110 and 4.9 for the December time period as shown in column 115. Further, the electronic device can calculate an overall product factor based on the weights of the component-related features for each of the time periods as shown in columns 110, 115 by dividing the total scores by a common number or “par score”. In the chart 100 as illustrated in FIG. 1, the par score is set as 4 and, accordingly, the respective overall product factors for the time periods as shown in columns 110, 115 are 1.325 and 1.225. It should be appreciated that the total scores, the par score, and the overall product factors can be assigned, calculated, or determined according to any parameters, technique, calculation, or algorithm.

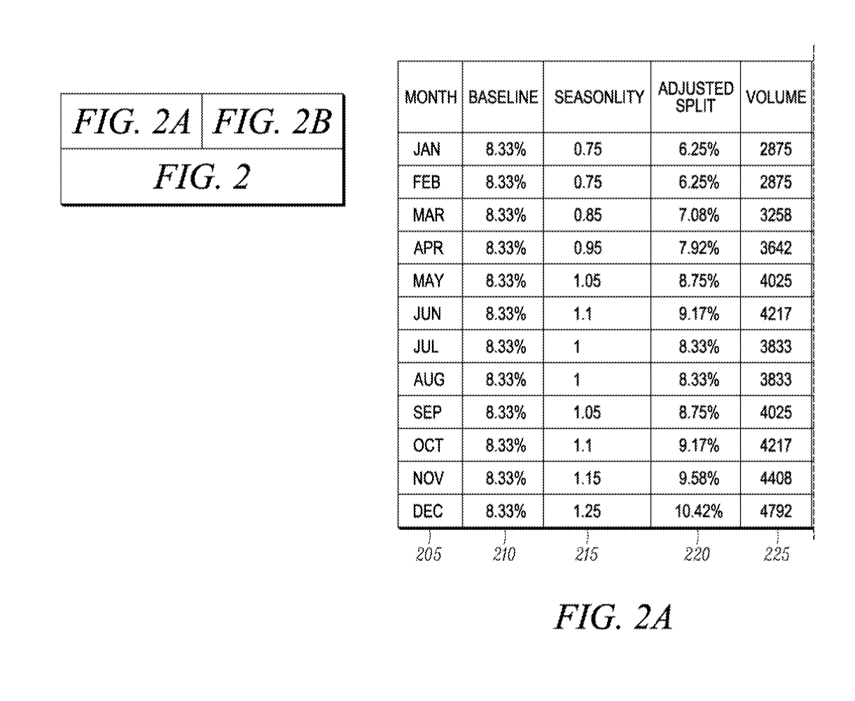

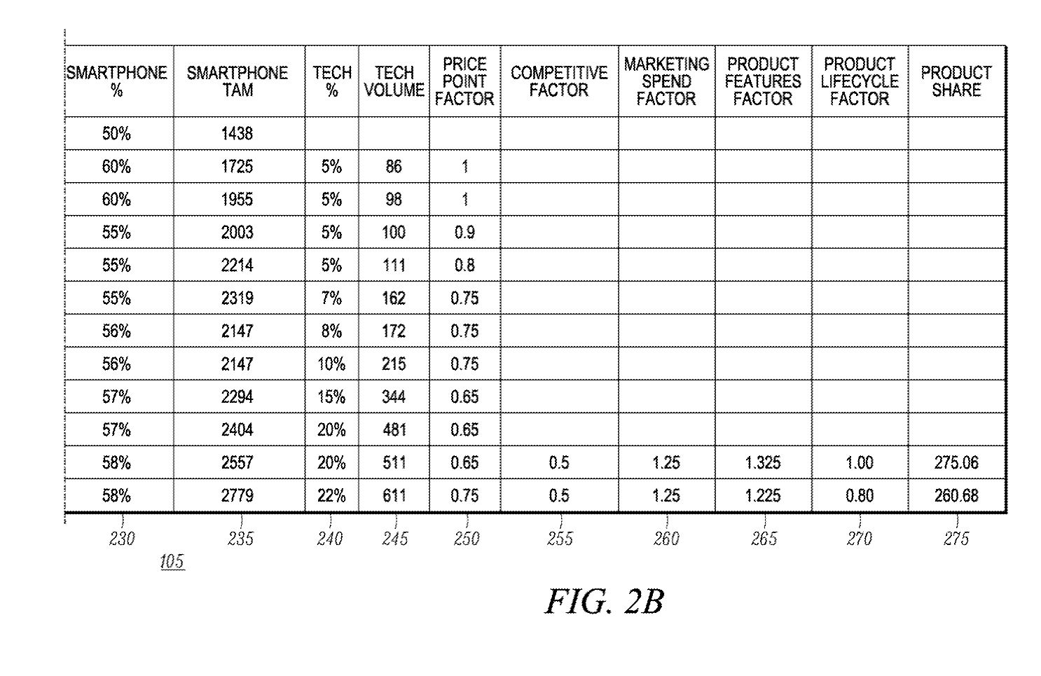

According to embodiments, the systems and methods can estimate a SAM for the product at various time periods based on the overall product factors and one or more other factors. FIG. 2 depicts an example chart 200 that details example factors that the systems and methods can use to determine the SAM forecast for the product. It should be appreciated that the depicted factors in the chart 200 are merely examples, and that the SAM forecast for the various time periods can be calculated using other factors and according to various algorithms or calculations. Further, for purposes of explaining the chart 200, it can be assumed that the product is a mobile smartphone. However, it should be appreciated that other products are envisioned.

The systems and methods can estimate a yearly TAM for the smartphone product. In embodiments, the systems and methods can estimate the yearly TAM based on historical sales data, year-over-year growth data, customer projections, third party source data, and/or other information or data. For purposes of explaining the chart 200, it can be assumed that the yearly sales volume for mobile phones is estimated to be 46,000 units. These volume estimates may be obtained from market research firms, market analysts, and other sources. As shown in FIG. 2, the chart 200 includes a month column 205, a baseline column 210, a seasonality column 215, an adjusted split column 220, and volume column 225. Particularly, the baseline column 210 indicates that each month of the month column 205 has an equal share of the yearly TAM. When the electronic device factors in the seasonality (column 215), such as when certain months experience a decreased or increased sales volume, the resulting adjusted split column 220 identifies each month's share. Further, the volume column 225 indicates the estimated TAM for each month based on the values of the adjusted split column 225, wherein the sum total of the values of the volume column 225 equals the estimated yearly TAM (here: 46,000 mobile phone units).

As shown in FIG. 2, the chart 200 further includes a smartphone percentage column 230 and a smartphone TAM column 235. In this example, direct data is available for past sales of mobile phones, which is then used to estimate the future TAM for mobile phones. A sub-category of smartphones is then estimated as a percentage of the overall category of mobile phones because direct data for smartphones is not available. In embodiments, the values of the smartphone percentage column 230 can be estimated based on analyzing monthly historical sales data, import data, or other data for a specified time period. For example, the data can be sales data corresponding to the mix of smartphone and non-smartphone products purchased by one or more major customers over the past two years. Further, the systems and methods can analyze the data to estimate the corresponding smartphone and non-smartphone percentages for a customer for each of the coming twelve months. As shown in FIG. 2, the electronic device can calculate the values of the smartphone TAM column 235 by multiplying the values of the volume column 225 by the values of the smartphone percentage column 230. Alternately, if market research firms have captured smartphone sales volumes directly, then the historical sales volume for smart phones may be used initially and the smartphone percentage column 230 and the smartphone TAM column 235 are not needed.

As further shown in FIG. 2, the chart 200 further includes a technology percentage column 240 and a technology volume column 245. Smartphone technologies include, as examples, GSM/EDGE, UMTS/HSPA, and LTE. In embodiments, the values of the technology percentage column 240 can be estimated based on knowledge of technology trials, technology deployment plans, on-going technology deployment, or completed technology deployment by service providers. Also, the values of the technology percentage column 240 can be determined based on third party and customer estimates for smartphone technology adoption by end users based not only on server provider deployment but also on trends in sales to end users. As shown in FIG. 2, the electronic device can calculate the values of the technology volume column 245 by multiplying the values of the technology percentage column 240 by the values of the smartphone TAM column 235. Thus, if the product uses LTE technology, the estimated LTE portion of the smartphone TAM is calculated. If a product does not have a technology factor, the technology percentage column 240 and the technology volume column 245 are not needed.

The chart 200 further includes a price point factor column 250. According to embodiments, the systems and methods can determine the corresponding price point factors by analyzing third party and customer sales data for sales of products at various price points, as well as by examining price point estimates for the product from a marketing or pricing (or similar) group. For example, as shown in FIG. 2, the price point factor decline from February through November may be a result of a determination that customers or consumers of the smartphone product may be less willing to pay the initial offering price as the months progress. For further example, as shown in FIG. 2, the price point factor can increase from November to December because the marketing group anticipates a holiday sale for the smartphone (i.e., a price decrease from the initial offering price occurs in December).

Further, the chart 200 includes a competitive factor column 255 that accounts for an amount of competing products at, near, or below the price point of the smartphone product at similar or newer lifecycle stages. In embodiments, the systems and methods can assign or determine a weight to each of the competing products, and can determine the associated competitive factors based on the weights. For example, as shown in FIG. 2, if a competing smartphone at a similar price point is being released on November, then the competitive factor for November is 0.5. The chart 200 further includes a marketing spend factor column 260. Particularly, the systems and methods can determine the associated marketing spend factors by analyzing historical sales performance and correlations to marketing spending amounts, such as internal and external market development funds. In this way, the more the enterprise budgets for the marketing of the product, the higher the marketing spend factor.

As shown in FIG. 2, the chart further includes a product features factor column 265 and a product lifecycle factor column 270. Particularly, the product features factor column 265 is populated with the product features values as discussed with respect to FIG. 1 (as shown: 1.325 for November and 1.225 for December). Further, the systems and methods can determine the product lifecycle factors based on an estimated lifecycle of the product. For example, if the smartphone product factor is being released in November with an estimated lifespan of 5 months, the smartphone product factor can decrease by 20% for each subsequent month (i.e., starts at 1.00 for November and decreases to 0.80 for December).

According to embodiments, the chart 200 includes a product share column 275 wherein the systems and methods can calculate product share of available market (SAM) values for the product based on the other values of the chart 200. Particularly, the systems and methods can calculate the SAM values for the particular time periods by multiplying the technology volume values of column 245 by the price point factors (250), the competitive factors (255), the marketing spending factors (260), the product features factors (265), and the product lifecycle factors (270). As shown in FIG. 2, the respective SAM values for November and December are 275.06 and 280.68. Stated differently, the systems and methods predict that of the 2557 and 2779 smartphones expected as the TAM for November and December, that there will be 275 and 281 of this particular model smartphone sold in November and December.

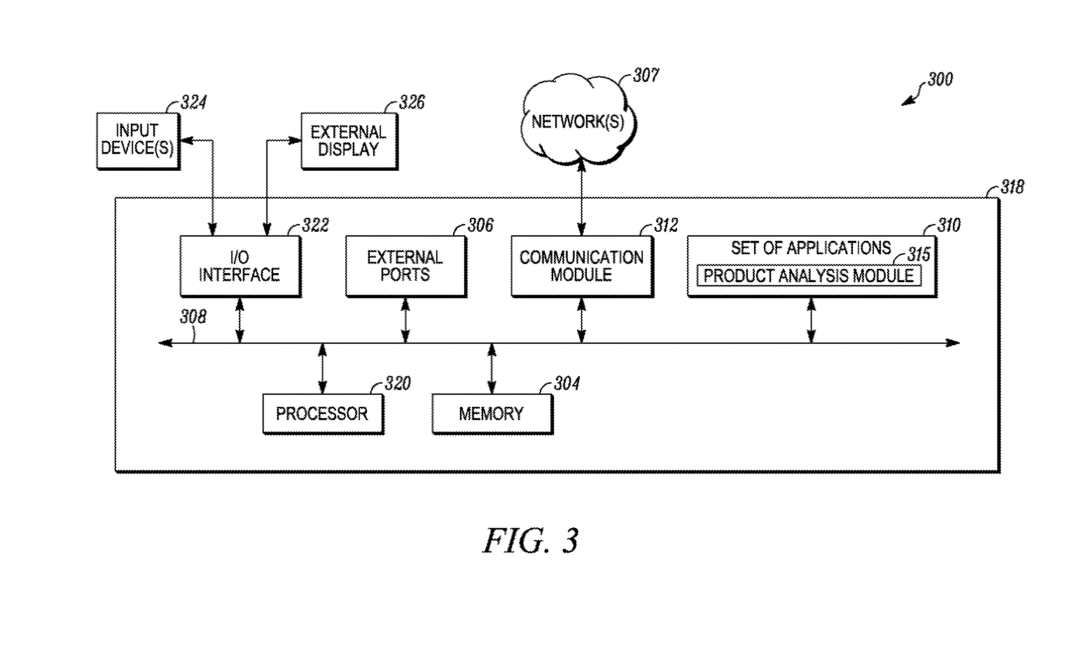

FIG. 3 illustrates an example computing system 300 in which the embodiments may be implemented. The electronic device 300 can include a processing module 318 including a combination of hardware and software components. Particularly, the processing module 318 includes a processor 320, memory 304 (e.g., hard drives, flash memory, MicroSD cards, and others), and one or more external ports 306 (e.g., Universal Serial Bus (USB), HDMI, Firewire, and/or others). The processing module 318 can further include a communication module 312 configured to interface with the one or more external ports 306 to communicate via one or more wired or wireless networks 307 such as, for example a wide area network (WAN), local area network (LAN), personal area network (PAN), and/or others. For example, the communication module 312 can include one or more transceivers (e.g., WWAN, WLAN, and/or WPAN transceivers) functioning in accordance with IEEE standards, 3GPP standards, or other standards, and configured to receive and transmit data via the one or more external ports 306. The components of the processing module 318 are capable of communicating with each other via a communication bus 308.

The processing module 318 can further include an input/output (I/O) interface 322 capable of communicating with one or more input devices 324 (e.g., keyboard, mouse, touchscreen, etc.) and an external display 326. The external display 326 and the input devices 324 may be considered to form portions of a user interface (e.g., portions of the computing system 300 associated with presenting information to a user and/or receiving inputs from the user).

As shown in FIG. 3, the processing module 318 can further include a set of applications 310 that are configured to interface with other components of the computing system 300 to facilitate the functionalities of the systems and methods as described herein. Particularly, the set of applications 310 can include a product analysis module 315 that can be capable of receiving or identifying various data inputs or parameters associated with a product, and calculating the SAM for the product over various time periods, various pricing and budget parameters, and other data and information.

In general, a computer program product in accordance with an embodiment includes a computer usable storage medium (e.g., standard random access memory (RAM), an optical disc, a universal serial bus (USB) drive, or the like) having computer-readable program code embodied therein, wherein the computer-readable program code is adapted to be executed by the processor 320 (e.g., working in connection with an operating system) to implement a user interface method as described below. In this regard, the program code may be implemented in any desired language, and may be implemented as machine code, assembly code, byte code, interpretable source code or the like (e.g., via C, C++, Java, Actionscript, Objective-C, Javascript, CSS, XML, and/or others).

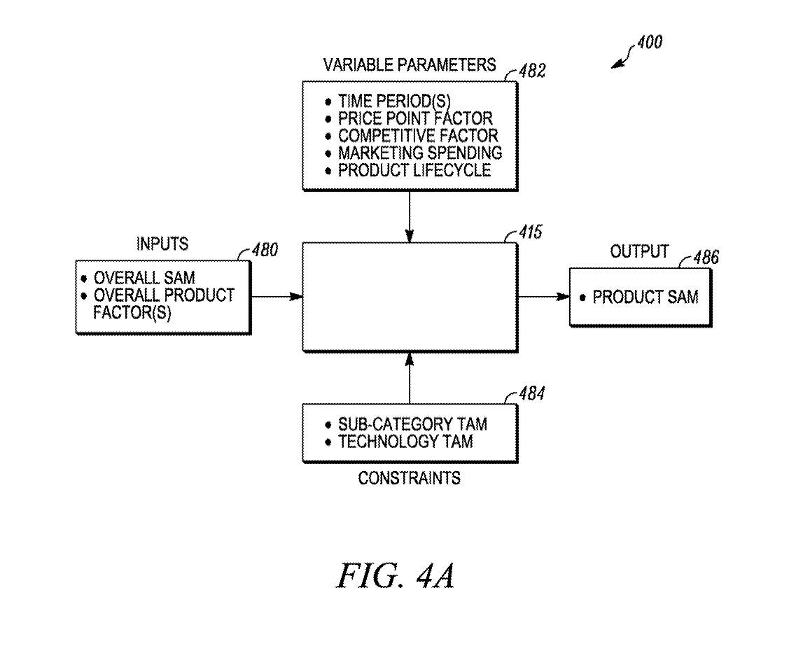

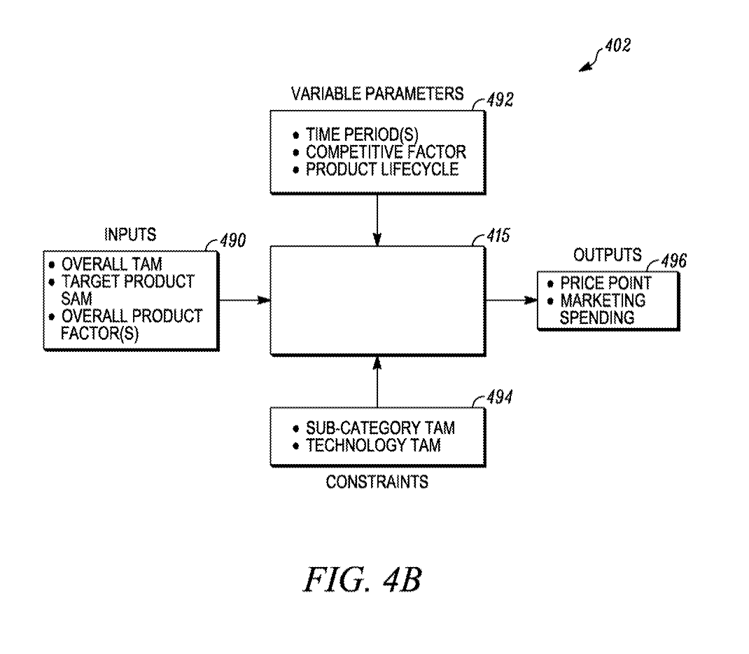

Referring to FIG. 4A, illustrated is a diagram 400 associated with a present embodiment of calculating a product's share of available market (SAM) for a particular product, and the inputs, variable parameters, constraints, and outputs associated therewith. The diagram 400 includes a product analysis module 415 (such as the product analysis module 315 as discussed with respect to FIG. 3) having instructions for calculating the product SAM forecast.

As illustrated in FIG. 4A, the product analysis module 415 may be instructed to execute a sales volume model for a product and output an associated product SAM. Inputs 480 for such a model can include an overall TAM for the product category and overall product factor(s). Particularly, the overall TAM can be estimated or calculated based on external-source or internal-source data, as discussed herein. Further, the overall product factors can be specified according to a comparison with any competitor products, as discussed with respect to FIG. 1. In embodiments, the overall product factors can be refined or updated at any point in time based on any further comparisons with competitor products, as well as on analyses of reviews associated with the product and/or with competitor products, and remaining supplies of any of the components of the product.

As further illustrated in FIG. 4A, variable parameters 482 for the sales volume model can include time period(s), a price point factor, a competitive factor, a marketing spending factor, and a product lifecycle factor. Further, constraints 484 for the sales volume model can include a sub-category TAM and a technology TAM. For example, if the product is a smartphone, the sub-category TAM can be based on historical data associated with smartphones as a sub-category of mobile phones, and the technology TAM can be based on technologies of the smartphone. Note that, from another point of view, the technology TAM can be considered a sub-sub-category TAM. According to embodiments, the product analysis module 415 can output a product SAM 486 based on the inputs, variable parameters, and constraints, as discussed herein. The SAM 486 can have multiple values associated with multiple time periods.

Referring to FIG. 4B, illustrated is a diagram 402 associated with a present embodiment of calculating spending and marketing figures for a particular product, and the inputs, variable parameters, constraints, and outputs associated therewith. The diagram 402 includes the product analysis module 415 (such as the product analysis module 315 as discussed with respect to FIG. 3) having instructions for calculating the spending and marketing figures.

As illustrated in FIG. 4B, the product analysis module 415 may be instructed to execute a sales volume model for a product and output the associated spending and marketing figures to achieve the target product SAM given as an input 490. Other inputs 490 for such a model can include an overall TAM for the product category and the overall product factor(s). Particularly, the overall TAM for the product category can be estimated or calculated based on external-source or internal-source data, as discussed herein. Further, the overall product factors can be specified according to a comparison with any competitor products, as discussed herein. In embodiments, the overall product factors can be refined or updated at any point in time based on any further comparisons with competitor products, as well as on analyses of reviews associated with the product and/or with competitor products, and remaining supplies of any of the components of the product. Still further, the target product SAM can correspond to a target sales amount for the product over one or more specified time periods. In embodiments, the target product SAM can be set according to component supply amounts and other factors. For example, an enterprise can set a target product SAM for a notebook computer for a particular month based on a component supplier indicating how many display screens of the subject product will be available for that month.

As further illustrated in FIG. 4B, variable parameters 492 for the sales volume model can include time period(s), a competitive factor, and a product lifecycle factor. Further, constraints 494 for the sales volume model can include a sub-category TAM and a technology TAM. For example, if the overall TAM product category is portable computers (i.e., including laptops, notebooks, and netbooks), and the product is a netbook computer, the product TAM can be based on historical data associated with netbook computers and the technology TAM can be based on network access technologies of the notebook computer (e.g., Ethernet, WiFi, WiMAX, or cellular 3G). According to embodiments, outputs 496 for the sales volume model can include a target price point and marketing spending amounts. Particularly, the target price point and marketing spending amounts can be estimated figures for a manufacturer of the product to use to achieve the target product SAM. For example, if component supplies for a product are low (or high) and therefore the target product SAM is low (or high), then the product analysis module 415 can output a high (or low) target price point and low (or high) marketing spending amounts.

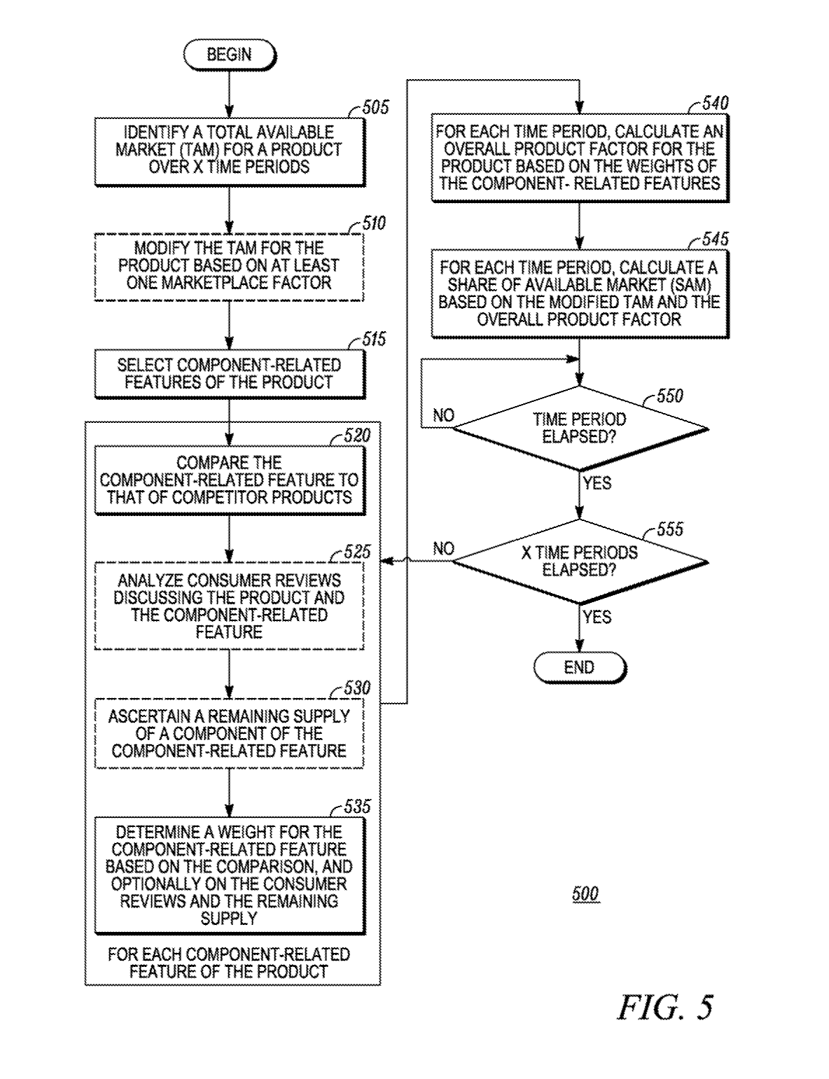

FIG. 5 is a flowchart of a method 500 for an electronic device (such as the computing system 300 as described with respect to FIG. 3) to determine and update a SAM forecast for a specific product over a plurality of time periods. More particularly, the method 500 relates to estimating a SAM forecast for the product before the launch of the product and updating the SAM forecast after the launch of the product.

The method 500 begins with the electronic device identifying 505 a total available market (TAM) for a product over X time periods. In embodiments, the time periods can correspond to days, weeks, months, years, or any other time period, and “X” can be any amount. Further, the electronic device can identify the TAM for the product based on any data or calculation or algorithm. The electronic device optionally modifies 510 the TAM for the product based on at least one marketplace factor. For example, the marketplace factors can be one or more of seasonality data, sub-category information, historical sales data for that type of product, technology penetration and/or adoption data, price point factors, competitive factors, marketing spending factors, product lifecycle factors, or others.

The electronic device selects 515 component-related features of the product. In some embodiments, the component-related features can be automatically determined or selected from a pre-set list. In other embodiments, a user can interface with the electronic device to select the component-related features. For each component-related feature of the product, the electronic device compares 520 the component-related feature to that of one or more competitor products. For example, if the product is a smartphone, the electronic device can compare the processor speed of the smartphone to the processor speeds of any competing smartphones and determine a general ranking of all of the smartphones currently available in the market. In embodiments, the electronic device can compare the component-related feature to similar or equivalent features of competitor products in the same product category or sub-category.

Further, for each component-related feature of the product, the electronic device optionally analyzes 525 professional and amateur consumer reviews that discuss the product and the component-related feature. Professional reviews may be performed by trade journalists and published in print or on-line magazines while amateur reviews are generally performed by unaffiliated individuals and published in on-line review forums or as comments to on-line magazine articles. Particularly, the electronic device can identify assessments of the component-related features from the reviews to determine that the consumers place greater or lesser weights on the importance of certain of the component-related features. For example, if the product is a smartphone, the electronic device can determine from the reviews that consumers place a higher importance on the battery capacity and a lower importance on the processor speed. In embodiments, the electronic device can analyze consumer reviews of any of the competitor products to further ascertain an importance of the component-related features and further adjust the weightings based on the relative importance of a component-related feature as determined through consumer review analysis.

Further, for each component-related feature of the product, the electronic device optionally ascertains 530 a remaining supply of a component of the component-related feature. In some cases, if the product has been released, the electronic device can identify an actual sales volume of the product over a certain time period that can be based on the remaining supply of the component. Further, for each component-related feature of the product, the electronic device determines 535 a weight for the component-related feature based on the comparison to the component-related feature of competitor products, and optionally based on the consumer reviews and the remaining supply of the component.

For each time period, the electronic device calculates 540 an overall product factor for the product based on the weights of the component-related feature. For example, the electronic device can calculate twelve overall product factors, each corresponding to a month time period over the course of a year. Further, for each time period, the electronic device calculates 545 a share of available market (SAM) based on the modified TAM from 510 and the overall product factor from 540. According to embodiments, the SAM can be a forecast of the amount of product units that will be sold for that particular time period.

The electronic device determines 550 whether a time period of the X time periods has elapsed. If the time period has elapsed (“YES”), the electronic device determines 555 whether the X time periods have elapsed. If the X time periods have not elapsed (“NO”), the electronic device repeats the functionalities of 520, 525, 530, and 535 to update the weight for each component-related feature of the product. Particularly, the electronic device can update the weights for the component-related features based on a comparison to the component-related features in any competitor products, an analysis of consumer reviews for the product (and/or competitor products), and/or an ascertainment of a remaining supply of a component of the component-related feature. If the X time periods have elapsed (“YES”), then the functionality of the method 500 can end, repeat, or return to any previous functionality.

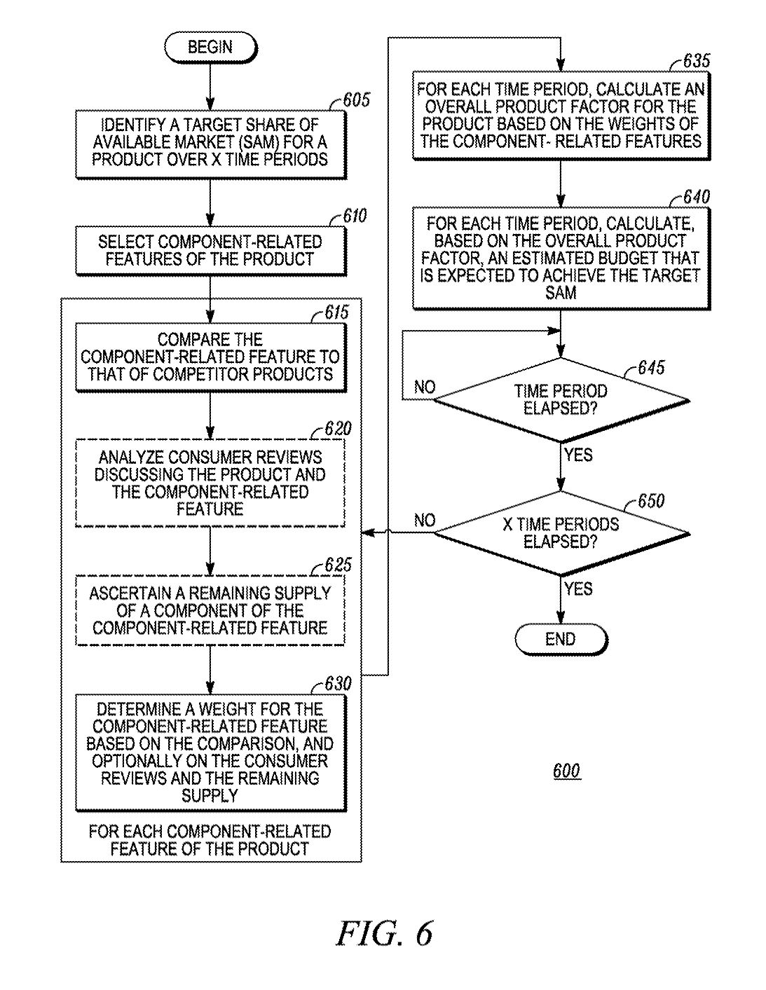

FIG. 6 is a flowchart of a method 600 for an electronic device (such as the computing system 300 as described with respect to FIG. 3) to estimate or update a budget associated with a target SAM over a plurality of time periods. More particularly, the method 600 relates to estimating a spending/marketing budget for the product before the launch of the product and updating the budget after the launch of the product.

The method 600 begins with the electronic device identifying 605 a target share of available market (SAM) for a product over X time periods. In embodiments, the time periods can correspond to days, weeks, months, years, or any other time period (with X being any amount), and the target SAM can correspond to a sales target for the product over the X time periods. Further, the electronic device can identify the target SAM for the product based on any data or calculation or algorithm. For example, the electronic device can identify the target SAM based on product-specific factors such as component supplies, as well as marketplace factors such as seasonality data, historical sales data for that type of product, technology penetration and/or adoption data, competitive factors, product lifecycle factors, or others.

The electronic device selects 610 component-related features of the product. In some embodiments, the component-related features can be automatically determined or selected from a pre-set list. In other embodiments, a user can interface with the electronic device to select the component-related features. For each component-related feature of the product, the electronic device compares 615 the component-related feature to that of one or more competitor products. For example, if the product is a flat screen television, the electronic device can compare the display brightness of the flat screen television to the display brightness of any competing flat screen televisions and determine a general ranking of all of the flat screen televisions available in the market. In embodiments, the electronic device can compare the component-related feature to similar or equivalent features of competitor products.

Further, for each component-related feature of the product, the electronic device optionally analyzes 620 professional and amateur consumer reviews that discuss the product and the component-related feature. Professional reviews may be performed by trade journalists and published in print or on-line magazines or newsletters while amateur reviews are generally performed by unaffiliated individuals and published in on-line review forums or as comments to on-line articles. Particularly, the electronic device can identify assessments of the component-related features from the reviews to determine that consumers place greater or lesser weights on the importance of certain of the component-related features. For example, if the product is a flat screen television, the electronic device can determine from the reviews that consumers place a higher importance on the display brightness and a lower importance on the display resolution. In embodiments, the electronic device can analyze consumer reviews of any of the competitor products to further ascertain an importance of the component-related features and further adjust the weightings based on the relative importance of a component-related feature as determined through consumer review analysis.

Further, for each component-related feature of the product, the electronic device optionally ascertains 625 a remaining supply of a component of the component-related feature. In some cases, if the product has been released, the electronic device identifies an actual sales volume of the product over a certain time period that can be based on the remaining supply of the component. Additionally, the electronic device can ascertain the remaining supply by identifying a constriction or expansion of components that are estimated to be available over one or more of any of the upcoming time periods. For example, a component supplier may anticipate a decrease in component supplies for a particular month. Referring to FIG. 6, for each component-related feature of the product, the electronic device determines 630 a weight based on the comparison to the component-related feature of competitor products, and optionally based on the consumer reviews and the remaining supply of the component.

For each time period, the electronic device calculates 635 an overall product factor for the product based on the weights of the component-related feature. For example, the electronic device can calculate twelve overall product factors, each corresponding to a month time period over the course of a year. Further, for each time period, the electronic device calculates 640, based on the overall product factor, an estimated budget that is expected to achieve the target SAM. According to embodiments, the estimated budget can include estimated figures for a pricing of the product, a promotion budget (e.g., marketing spending), and/or other figures.

The electronic device determines 645 whether a time period of the X time periods has elapsed. If the time period has elapsed (“YES”), the electronic device determines 650 whether the X time periods have elapsed. If the X time periods have not elapsed (“NO”), the electronic device repeats the functionalities of 615, 620, 625, 630 to update the weight for each component-related feature of the product. Particularly, the electronic device can update the weights for the component-related features based on a comparison to the component-related features in any competitor products, an analysis for consumer reviews for the product (and/or competitor products), and/or an ascertainment of a remaining supply of a component of the component-related feature. If the X time periods have elapsed (“YES”), then the functionality of the method 600 can end, repeat, or return to any previous functionality.

Thus, it should be clear from the preceding disclosure that the systems and methods offer improved sales models associated with product releases. The systems and methods advantageously allow companies and enterprises to more accurately predict sales for a product by analyzing component-related features of competitor products. Further, the systems and methods advantageously allow companies to estimate various spending budgets according to target sales amounts for a product based on analyses of component-related features of competitor products.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A method in an electronic device of estimating sales of a product, the method comprising:
identifying a total available market (TAM) for the product over a specified time period, the product having at least one component-related feature;
for each of the at least one component-related feature of the product:
comparing the component-related feature of the product to the component-related feature of at least one competing product, and
determining a weight for the component-related feature of the product based on the comparing;
calculating, by a processor, an overall product factor based on the weight for each of the at least one component-related feature of the product; and
applying the overall product factor to the TAM to determine a share of available market (SAM) for the product over the specified time period.

2. The method of claim 1, further comprising:
after a portion of the specified time period has elapsed, analyzing one or more reviews associated with at least one of 1) the product or 2) the at least one competing product;
modifying the overall product factor based on the analyzing; and
updating the share of available market (SAM) for the product over a remainder of the specified time period based on the overall product factor that was modified.

3. The method of claim 2, wherein the one or more reviews are from one or more of 1) a customer that purchased the product or 2) a consumer who used the product.

4. The method of claim 2, wherein the analyzing the one or more reviews comprises:
identifying, in each of the one or more reviews, an assessment of the at least one component-related feature of the product; and
modifying the weight for each of the at least one component-related feature based on the assessment.

5. The method of claim 1, wherein the specified time period comprises a plurality of sub time periods and wherein the applying the overall product factor to the total available market (TAM) comprises determining a sub share of available market (SAM) for the product over each of the plurality of sub time periods.

6. The method of claim 1, further comprising:
after a portion of the specified time period has elapsed, identifying a remaining supply of a component associated with the at least one component-related feature;
modifying the overall product factor based on the remaining supply; and
updating the share of available market (SAM) for the product over a remainder of the specified time period based on the overall product factor that was modified.

7. The method of claim 1, wherein the total available market (TAM) is based on one or more of historical sales data, technology penetration estimates, an availability of the at least one competing product, or lifecycle data for the product.

8. The method of claim 1, wherein the at least one component-related feature of the product is one or more of a processor, a display, a battery, a memory, a sensor, or a camera.

9. A method in an electronic device of estimating budget parameters associated with a product, the method comprising:
identifying a target share of available market (SAM) for the product over a specified time period, the product having at least one component-related feature;
for each of the at least one component-related feature of the product:
comparing the component-related feature of the product to the component-related feature of at least one competing product, and
determining a weight for the component-related feature of the product based on the comparing;
calculating, by a processor, an overall product factor based on the weight for each of the at least one component-related feature of the product; and
determining, based on the overall product factor, a budget associated with the target SAM for the product over the specified time period.

10. The method of claim 9, wherein the budget relates to one or more of a price point for the product or a marketing budget.

11. The method of claim 9, further comprising:
after a portion of the specified time period has elapsed, identifying an actual sales volume of the product over the portion of the specified time period;
based on the actual sales volume, updating the budget associated with the target share of available market (SAM) for the product over a remainder of the specified time period.

12. The method of claim 9, further comprising:
after a portion of the specified time period has elapsed, analyzing one or more reviews associated with at least one of 1) the product or 2) the at least one competing product;
modifying the overall product factor based on the analyzing; and
updating the budget associated with the target share of available market (SAM) for the product over a remainder of the specified time period based on the overall product factor that was modified.

13. The method of claim 9, further comprising:
identifying an available supply of a component associated with the at least one component-related feature for a portion of the specified time period; and
based on the available supply, updating the budget associated with the target share of available market (SAM) for the product over the portion of the specified time period.

14. A processing device for estimating sales of a product, the processing device comprising:
at least one processor; and
a memory device which stores a plurality of instructions, which when executed by the at least one processor cause the at least one processor to perform operations including:
identifying a total available market (TAM) for the product over a specified time period, the product having at least one component-related feature,
for each of the at least one component-related feature of the product:
comparing the component-related feature of the product to the component-related feature of at least one competing product, and
determining a weight for the component-related feature of the product based on the comparing,
calculating an overall product factor based on the weight for each of the at least one component-related feature of the product, and
applying the overall product factor to the TAM to determine a share of available market (SAM) for the product over the specified time period.

15. The processing device of claim 14, wherein, when executed by the at least one processor, the plurality of instructions cause the at least one processor to perform operations further comprising:
after a portion of the specified time period has elapsed, analyzing one or more reviews associated with at least one of 1) the product or 2) the at least one competing product,
modifying the overall product factor based on the analyzing, and
updating the share of available market (SAM) for the product over a remainder of the specified time period based on the overall product factor that was modified.

16. The processing device of claim 15, wherein the analyzing the one or more reviews comprises:
identifying, in each of the one or more reviews, an assessment of the at least one component-related feature of the product, and
modifying the weight for each of the at least one component-related feature based on the assessment.

17. The processing device of claim 14, wherein the specified time period comprises a plurality of sub time periods and wherein the applying the overall product factor to the TAM comprises determining a sub share of available market (SAM) for the product over each of the plurality of sub time periods.

18. The processing device of claim 14, wherein, when executed by the at least one processor, the plurality of instructions cause the at least one processor to perform operations further comprising:
after a portion of the specified time period has elapsed, identifying a remaining supply of a component associated with the at least one component-related feature,
modifying the overall product factor based on the remaining supply, and
updating the share of available market (SAM) for the product over a remainder of the specified time period based on the overall product factor that was modified.

19. The processing device of claim 14, wherein the total available market (TAM) is based on one or more of historical sales data, technology penetration estimates, an availability of the at least one competing product, or lifecycle data for the product.

20. The processing device of claim 14, wherein the at least one component-related feature of the product is one or more of a processor, a display, a battery, a memory, a sensor, or a camera.
